(19) United States
(12) Patent Application Publication
(10) Pub. No.: US 2026/0248684 A1
(43) Pub. Date: Aug. 27, 2026

(54) A NOZZLE ASSEMBLY FOR A SPA POOL AND A SPA POOL

(71) Applicant: Intex Marketing Ltd., Tortola (VG)

(72) Inventors: Zhi Xiong Huang, Fujian (CN); Ai Ming Tan, Fujian (CN)

(73) Assignee: Intex Marketing Ltd., Tortola (VG)

(21) Appl. No.: 18/874,693

(22) PCT Filed: Jun. 20, 2023
(86) PCT No.: PCT/IB2023/056394

§ 371 Date: Dec. 13, 2024

(30) Foreign Application Priority Data
Jun. 20, 2022 (CN) 202221545633.7

(51) Int. Cl. A61H 33/02; A61H 33/00

(52) U.S. Cl. CPC A61H 33/027; A61H 33/6005

(57) ABSTRACT

An improved nozzle assembly for a SPA pool is provided. The nozzle assembly may include a first nozzle, a second nozzle, and a water pipe. The first and second nozzles may each include air inlet ends and water inlet ends. The respective air inlet ends of the first and second nozzles may connect to an air inlet valve through an air pipe. The water inlet end of the first nozzle may connect to an inlet waterway, and the water inlet end of the second nozzle may connect to the inlet waterway through the water pipe.

### RELATED APPLICATIONS

This application is related to Chinese Application No. CN202221545633.7, filed Jun. 20, 2022, the entire disclosure of which is expressly incorporated herein by reference.

### FIELD OF THE DISCLOSURE

The present disclosure relates to a nozzle assembly, and in particular to a nozzle assembly for delivering massaging bubbles to a SPA pool.

### BACKGROUND OF THE DISCLOSURE

A conventional inflatable massage pool includes two primary structures: a pool and a nozzle assembly. To supply massaging aerated jets to different parts of the pool to, for example, simultaneously massage different parts of a user's body, a plurality of nozzles is needed. Depending on the size of the pool and the number of jetted water outlets, the number of nozzles may become large. Traditionally, one nozzle is adapted to one inlet waterway and one air valve. This results in a complex waterway and airway for the entire pool.

Improvements on the foregoing are desired.

### SUMMARY OF THE DISCLOSURE

The present disclosure provides a nozzle assembly for a SPA pool. Advantageously, a plurality of nozzles, such as two, share a common inlet waterway and airway, simplifying the structure.

In one form thereof, the present disclosure provides a nozzle assembly for a SPA pool. The nozzle assembly may comprise a first nozzle having an air inlet end and a water inlet end, a second nozzle having an air inlet end and a water inlet end, and a water pipe. The air inlet ends of the first and second nozzles may be connected to an air inlet valve through an air pipe. The water inlet end of the first nozzle may be connected to an inlet waterway, and the water inlet end of the second nozzle may be connected to the inlet waterway through the water pipe.

In another form thereof, the first nozzle and the second nozzle may each comprise a nozzle base and a nozzle. The water inlet ends and the air inlet ends of the first and second nozzles may be disposed in the respective nozzle bases of the first and second nozzles, and each nozzle may be inserted into the corresponding nozzle base and may rotate between a first position and a second position relative to the nozzle base under external force.

In another form thereof, the nozzle may comprise a water hole. When the nozzle is in the first position, the water hole may be connected to the nozzle base, and when the nozzle is in the second position, the water hole may be staggered from the nozzle base.

In another form thereof, the nozzle base may always be connected to the water inlet end.

In another form thereof, the nozzle base of the first nozzle may extend out of the water pipe on a side away from the water inlet end, and the water pipe may be inserted into the nozzle base of the second nozzle and fixedly connected to the second nozzle through a fixing nut.

In another form thereof, the water pipe may be a hose connected between the nozzle bases of the first nozzle and the second nozzle.

In another form thereof, the nozzle base of the first nozzle has a water outlet end on a side away from the water inlet end. The hose may be connected between the water outlet end of the first nozzle and the water inlet end of the second nozzle, and the hose is respectively fixed thereto by fixing nuts.

The present disclosure further provides a SPA pool, which may comprise a pool body and a nozzle assembly arranged on the pool body, and the nozzle assembly may be the nozzle assembly as described herein.

In another form thereof, the pool body may be an inflatable pool or a frame pool.

In another form thereof, the present disclosure provides a nozzle assembly for a SPA pool. The nozzle assembly may comprise an air inlet valve, a first nozzle, and a second nozzle. The air inlet valve may comprise an air inlet in fluid communication with ambient air, an internal volume in fluid communication with the air inlet, and a plurality of air outlets in fluid communication with the internal volume. The first nozzle may comprise an air inlet in fluid communication with a first of the plurality of air outlets and a water inlet in fluid communication with an inlet waterway. The second nozzle may comprise an air inlet in fluid communication with a second of the plurality of air outlets and a water inlet in fluid communication with the inlet waterway.

In another form thereof, the first nozzle may comprise a nozzle base and a nozzle head, the water inlet of the first nozzle may be formed in the nozzle base, the nozzle base may include a water outlet in fluid communication with the water inlet of the first nozzle, and the nozzle head may be rotatably received within the nozzle base to rotate between a first position and a second position.

In another form thereof, the nozzle head may include an internal fluid passageway having a water inlet hole and a water outlet and, when the nozzle head is in the first position, the water inlet hole may be opened relative to the water inlet of the first nozzle to place the internal fluid passageway of the nozzle head in fluid communication with the inlet waterway.

In another form thereof, the nozzle head may include an internal fluid passageway having a water inlet hole and a water outlet and, when the nozzle head is in the second position, the water inlet hole may be closed relative to the water inlet to fluidly isolate the internal fluid passageway of the nozzle head from the inlet waterway.

In another form thereof, the second nozzle may receive water from the inlet waterway independent of the nozzle head of the first nozzle such that when the nozzle head of the first nozzle is in the second position the second nozzle may maintain fluid communication with the inlet waterway.

In another form thereof, the nozzle assembly may further comprise a water pipe integrally formed with the nozzle base of the first nozzle and in fluid communication with the water outlet of the first nozzle and the water inlet of the second nozzle to place the second nozzle in fluid communication with the inlet waterway.

In another form thereof, the nozzle assembly may further comprise a water pipe removably couplable to the water outlet of the first nozzle and the water inlet of the second nozzle to place the second nozzle in fluid communication with the inlet waterway.

In another form thereof, the second nozzle may comprise a nozzle base and a nozzle head, the water inlet of the second nozzle may be formed in the nozzle base, the nozzle head may be rotatably received within the nozzle base to rotate between a first position and a second position.

In another form thereof, the nozzle head may include an internal fluid passageway having a water inlet hole and a water outlet and, when the nozzle head is in the first position, the water inlet hole may be opened relative to the water inlet to place the internal fluid passageway of the nozzle head in fluid communication with the inlet waterway.

In another form thereof, the nozzle head may include an internal fluid passageway having a water inlet hole and a water outlet and, when the nozzle head is in the second position, the water inlet hole may be closed relative to the water inlet to fluidly isolate the internal fluid passageway of the nozzle head from the inlet waterway.

In another form thereof, the first nozzle may receive water from the inlet waterway independent of the nozzle head of the second nozzle such that when the nozzle head of the second nozzle is in the second position the first nozzle may maintain fluid communication with the inlet waterway.

In another form thereof, when the nozzle head of the first nozzle is in the first position, water may be communicated from the inlet waterway to the second nozzle through an interior of the nozzle head of the first nozzle and when the first nozzle is in the second position, water may be communicated from the inlet waterway to the second nozzle externally to the nozzle head of the first nozzle.

In another form thereof, the first nozzle may further comprise a nozzle head, and the second nozzle may further comprise a nozzle head, the nozzle head of the first nozzle and the nozzle head of the second nozzle may be in independent fluid communication with the inlet waterway.

In another form thereof, the first air outlet and the second air outlet may be vertically offset relative to each other.

In another form thereof, the first air outlet and the second air outlet may be horizontally offset relative to each other.

In another form thereof, the present disclosure provides a fluid assembly for a SPA pool. The fluid assembly may comprise a plurality of air pipes, a first nozzle, a second nozzle, an inlet waterway, and a main supply line. The plurality of air pipes may be in fluid communication with ambient air. The first nozzle may comprise an air inlet in fluid communication with ambient air through a first air pipe of the plurality of air pipes, a water inlet, and a water outlet in fluid communication with the water inlet. The second nozzle may comprise an air inlet in fluid communication with ambient air through a second air pipe of the plurality of air pipes, and a water inlet in fluid communication with the water outlet of the first nozzle. The inlet waterway may be in fluid communication with the water inlet of the first nozzle and the water inlet of the second nozzle through the water inlet of the first nozzle and the water outlet of the first nozzle. The main supply line may be in fluid communication with the inlet waterway such that the first nozzle and the second nozzle receive water from the main supply line through the inlet waterway.

In another form thereof, the fluid assembly may further comprise a pump in fluid communication with the spa pool, the main supply line receiving water from the pump.

In another form thereof, the first nozzle may further comprise a nozzle base and a nozzle head rotatably received within the nozzle base to rotate between a first position and a second position, the water inlet and the water outlet may be formed in the nozzle base, and the nozzle head may comprise an internal fluid passageway having a water inlet hole and a water outlet, the water inlet hole may be in selective fluid communication with the water inlet.

In another form thereof, when the nozzle head is in the first position, the water inlet hole may be opened relative to the water inlet of the first nozzle to place the internal fluid passageway of the nozzle head in fluid communication with the inlet waterway.

In another form thereof, when the nozzle head is in the second position, the water inlet hole may be closed relative to the water inlet to fluidly isolate the internal fluid passageway of the nozzle head from the inlet waterway.

In another form thereof, the second nozzle may receive water from the inlet waterway independent of the nozzle head of the first nozzle such that when the nozzle head of the first nozzle is in the second position the second nozzle may maintain fluid communication with the inlet waterway.

In another form thereof, the second nozzle may further comprise a nozzle base and a nozzle head rotatably received within the nozzle base to rotate between a first position and a second position, the water inlet may be formed in the nozzle base, and the nozzle head may comprise an internal fluid passageway having a water inlet hole and a water outlet, the water inlet hole may be in selective fluid communication with the water inlet.

In another form thereof, when the nozzle head is in the first position, the water inlet hole may be opened relative to the water inlet of the second nozzle to place the internal fluid passageway of the nozzle head in fluid communication with the inlet waterway.

In another form thereof, when the nozzle head is in the second position, the water inlet hole may be closed relative to the water inlet of the second nozzle to fluidly isolate the internal fluid passageway of the nozzle head from the inlet waterway.

In another form thereof, the first nozzle may receive water from the inlet waterway independent of the nozzle head of the second nozzle such that when the nozzle head of the second nozzle is in the second position the first nozzle may maintain fluid communication with the inlet waterway.

In another form thereof, the first air pipe and the second air pipe may be vertically offset relative to each other.

In another form thereof, the first air pipe and the second air pipe may be horizontally offset relative to each other.

In another form thereof, the present disclosure provides an inflatable spa. The inflatable spa may comprise an inflatable wall and the fluid assembly according to the present disclosure. The inflatable wall may comprise an internal wall defining a water cavity and an external wall. The main supply line may be positioned within the inflatable wall.

In another form thereof, the inflatable spa may further comprise a plurality of air inlets formed in the external wall. The plurality of air inlets may be in fluid communication with ambient air.

In another form thereof, each air inlet of the plurality of air inlets may be in fluid communication with at least one of the plurality of air pipes.

Compared to the existing technology, the technical solution of the present disclosure has the following beneficial effects, among others that will be apparent to those skilled in the art:

The present disclosure provides a nozzle assembly for SPA pool, which can connect a plurality of nozzles, such as two nozzles, to the same inlet waterway and air inlet valve. Moreover, each nozzle can be independently opened and closed, without affecting the other nozzle's functions.

Additional features and advantages of the present disclosure will become apparent to those skilled in the art upon consideration of the following detailed description.

### BRIEF DESCRIPTION OF THE DRAWINGS

FIG. 1 is an exploded view of an embodiment of a nozzle assembly according to the present disclosure;

FIG. 2 is an installation diagram of the nozzle assembly of FIG. 1;

FIG. 3 is a cross-sectional view of the nozzle assembly of FIG. 1 depicting the first nozzle in an “on” configuration;

FIG. 4 is a cross-sectional view of the nozzle assembly of FIG. 1 depicting the first nozzle in an “on” configuration;

FIG. 5 is a cross-sectional view of the nozzle assembly of FIG. 1 depicting the first nozzle in an “off” configuration;

FIG. 6 is a cross-sectional view of the nozzle assembly of FIG. 1 depicting the first nozzle in an “off” configuration;

FIG. 7 is an exploded view of a second embodiment of a nozzle assembly according to the present disclosure;

FIG. 8 is a cross-sectional view the nozzle assembly of FIG. 7 depicting the first nozzle in an “open” configuration;

FIG. 9 is a cross-sectional view of the nozzle assembly of FIG. 7 depicting the first nozzle in an “on” configuration;

FIG. 10 is a cross-sectional view of the nozzle assembly of FIG. 7 depicting the first nozzle in an “off” configuration;

FIG. 11 is a cross-sectional view of the nozzle assembly of FIG. 7 depicting the first nozzle in an “off” configuration.

FIG. 12 is an exploded view of an embodiment of a nozzle assembly according to the present disclosure.

FIG. 13 is an exploded view of the nozzle assembly of FIG. 12.

FIG. 14 is a top plan view of an inflatable spa incorporating the nozzle assembly of the present disclosure.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure.

### DETAILED DESCRIPTION OF THE EMBODIMENTS

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

In the description of the present disclosure, it should be noted that the terms “up”, “down”, “inside”, “outside”, “top/bottom”, etc. indicate the orientation or position relationship based on the orientation or position relationship shown in the attached drawings, only for the convenience of describing the present disclosure and simplifying the description, rather than indicating or implying that the device or component referred to must have a specific orientation, or be constructed and operated in a specific orientation. Therefore, it cannot be understood as a limitation on the present disclosure. In addition, the terms “first” and “second” are only used to describe and cannot be understood as indicating or implying relative importance.

In the description of the present disclosure, it should be noted that unless otherwise specified and limited, the terms “installation”, “set with”, “set/connected”, “connected”, etc. should be understood broadly. For example, “connected” can be a wall mounted connection, a detachable connection, or an integrated connection, can be a mechanical connection, can be an electrical connection, can be directly connected, or can be indirectly connected through an intermediate medium, can be the internal connection between two components, and for ordinary technical personnel in this field, the specific meaning of the above terms in the present disclosure can be understood in a specific situation.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

### Embodiment 1

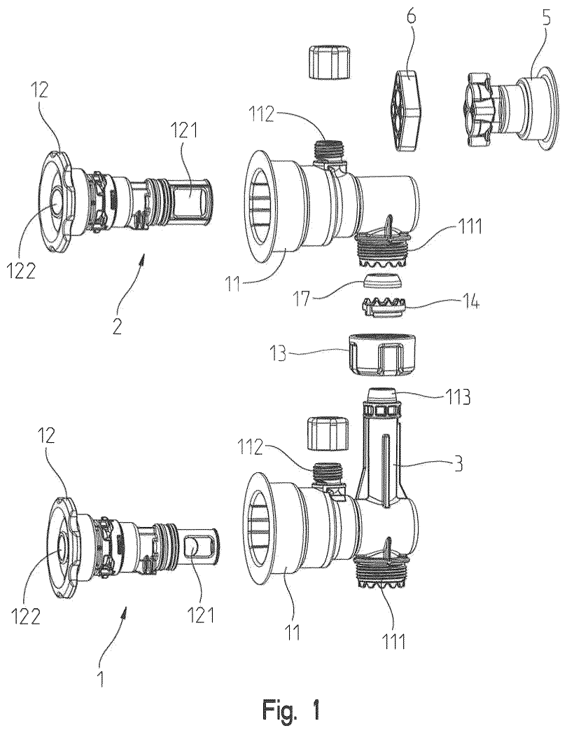

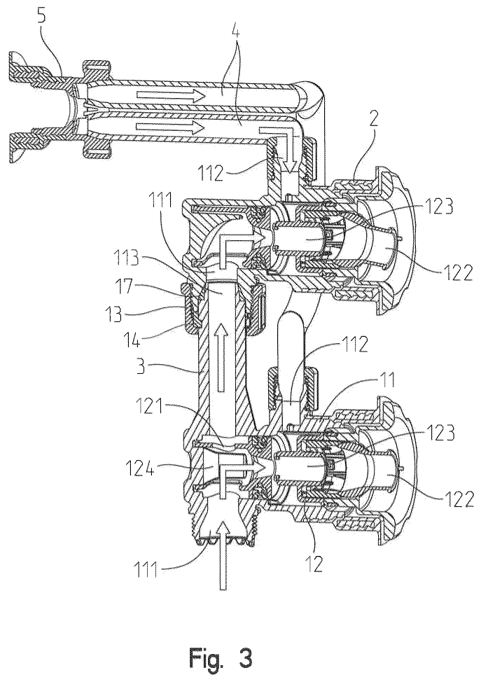

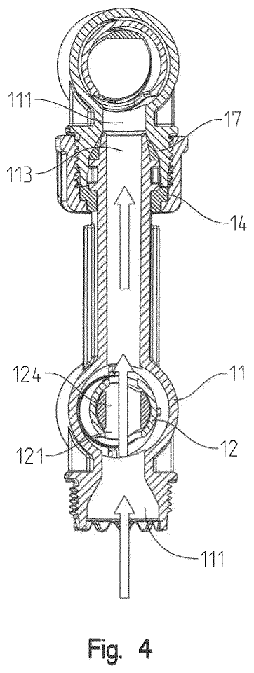

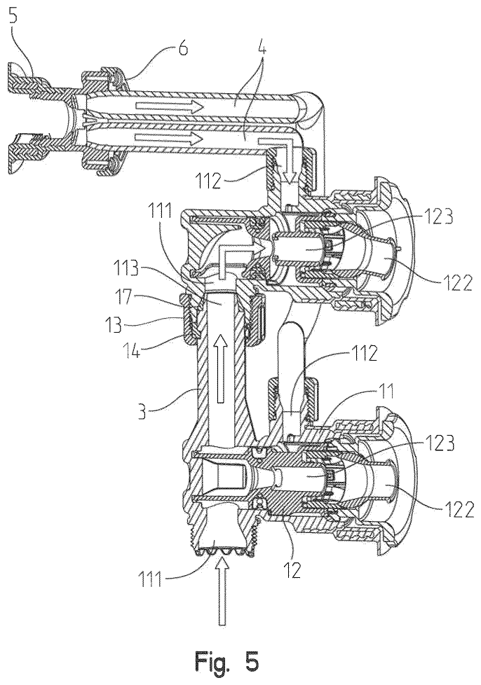

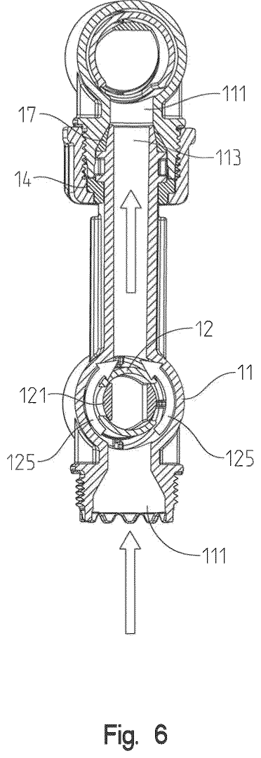

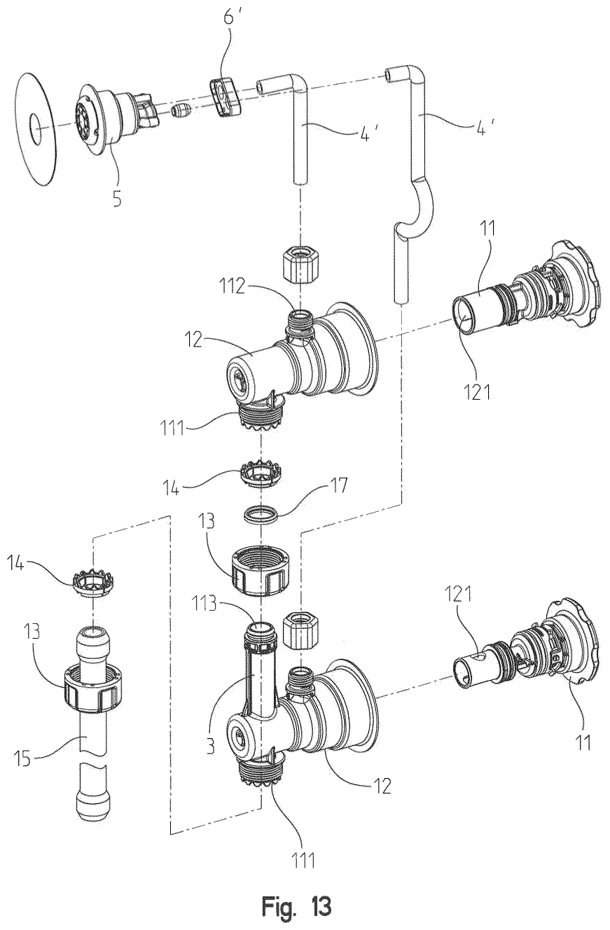

As shown in FIGS. 1 to 6 and 12-14, the present disclosure provides a nozzle assembly 100 for a SPA pool. The nozzle assembly 100 may comprise a first nozzle 1, a second nozzle 2, and a water pipe 3. Although two nozzles are shown, additional nozzles may be included.

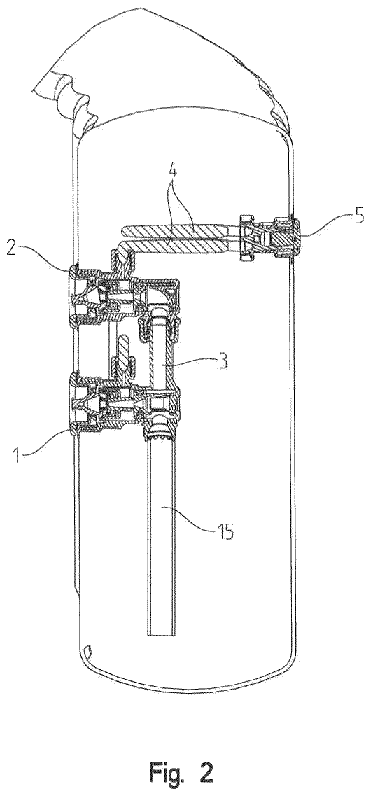

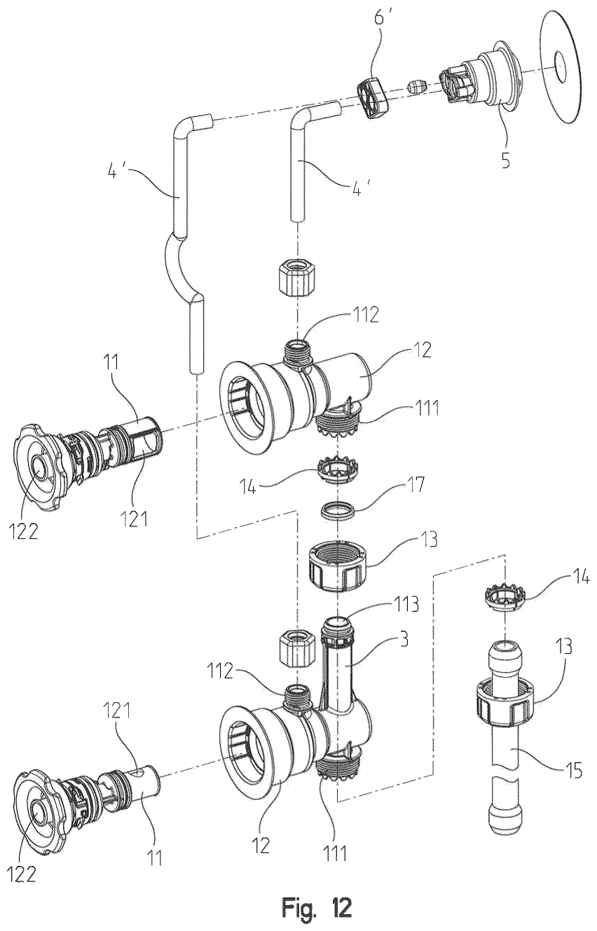

The first nozzle 1 and the second nozzle 2 each have an air inlet end 112, and the air inlet ends 112 are respectively connected to an air inlet valve 5 through an air pipe 4 and an adapter 6, 6′. Air pipes 4 are shown vertically oriented relative to one another in FIG. 2, and air pipes 4′ are shown horizontally oriented relative to one another in FIG. 12. Other orientations of the air pipes 4, 4′ are contemplated.

Although the illustrated embodiments depict air inlet valve 5 in fluid communication with ambient air, air valve 5 may also receive pressurized air. Air inlet valve 5 has an internal volume, and air received in the internal volume is subsequently diverted through adapter 6 to a plurality of air pipes 4 in fluid communication with the first nozzle 1 and the second nozzle 2 via respective air inlet ends 112.

The water inlet end of the first nozzle 1 is connected to the inlet waterway 15, and the water inlet end of the second nozzle 2 is connected to the inlet waterway 15 through the water pipe 3.

Advantageously, the nozzle assembly for a SPA pool discussed herein can achieve at least two nozzles connecting to the same inlet waterway 15 and air inlet valve 5. This simplifies the pipeline connection.

Because two nozzles are connected to the same inlet waterway 15, it would be very inconvenient if one nozzle was turned off and the other nozzle could not be used.

Therefore, the first nozzle 1 and the second nozzle 2 each comprise a nozzle base 11 and a nozzle head 12. The nozzle base 11 is formed with the water inlet end 111 and the air inlet end 112. The nozzle base 11 of each first nozzle 1 also includes a water outlet 113. A face of the nozzle head 12 may include grooves, notches, protrusions, or the like to assist the user in rotating the nozzle head.

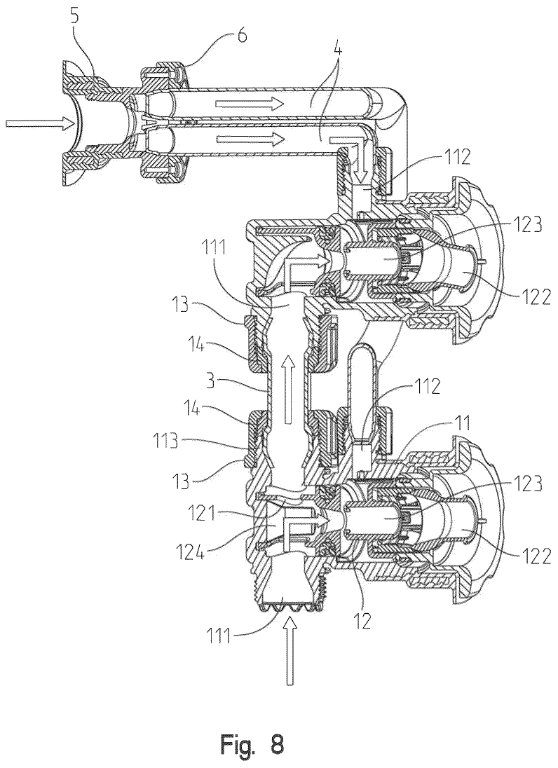

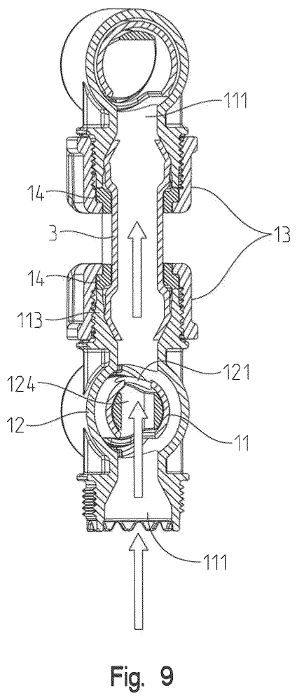

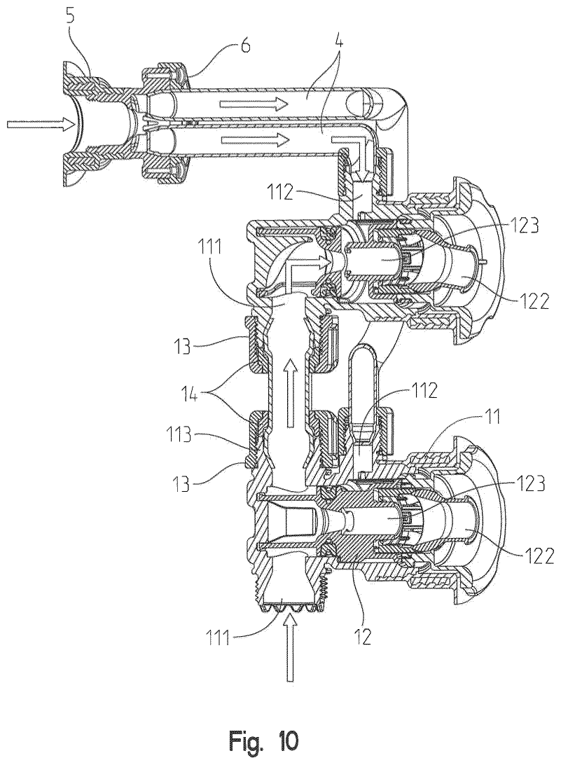

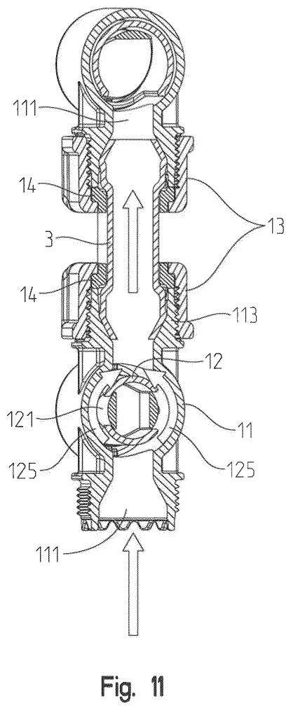

The nozzle head 12 is inserted into the nozzle base 11 and rotates between a first position and a second position relative to the nozzle base 11 under external force. The nozzle head 12 has a water inlet hole 121, a water outlet 122, and an internal fluid passageway 123 connecting the water inlet hole 121 to the water outlet 122. When the nozzle head 12 is in the first position, the water inlet hole 121 is aligned with the water inlet end 111 of the nozzle base 11 such that water can flow from the inlet waterway through the water inlet end 111 of the nozzle base 11, through the water inlet hole 121 of the nozzle head 12, and out of the nozzle head 12 into the water cavity of a spa or pool. In the first position, water may be communicated from the inlet waterway 14 to the second nozzle 2 through an interior 124 of the nozzle head 12 of the first nozzle 1. When the nozzle head 12 is in the second position, the water inlet hole 121 is staggered relative to the water inlet end 111 of the nozzle base 11 to prevent water from entering the nozzle head 12 from the inlet waterway 15. In the second position, water may be communicated from the inlet waterway 15 to the second nozzle 2 externally to the nozzle head 12 of the first nozzle 1 via a bypass 125 formed by the nozzle head 12 of the first nozzle 1 and the nozzle base 11 of the first nozzle 1. Regardless of the position of nozzle head 12, the nozzle base 11 remains connected to the water inlet end 111 at all times. In this way, as depicted in FIGS. 8-11, rotating two nozzle heads 12 can turn off the nozzles separately, and when the nozzle head 12 of the first nozzle I rotates to the second position, the water can still flow from the inlet waterway 15 to the second nozzle 2 normally. Therefore, even if the first nozzle 1 is turned off, the second nozzle 2 can still be used normally. Similarly, the second nozzle 2 may be turned off and the first nozzle 1 may remain in the on position.

As water flows through the nozzle head 12 of the first nozzle 1 and the second nozzle 2, respectively, the water flow effects a drop in pressure at the air inlet end 112 of the first nozzle 1 and the air inlet end 112 of the second nozzle 2. The pressure drop draws in ambient air through air inlet valve 5. Thus, when, for example, the nozzle head 12 of the first nozzle 1 is in the second position, there is no water flow through the nozzle head 12 to create a drop in pressure at the air inlet end 112 of the first nozzle 1, and thus no ambient air is drawn into the first nozzle 1.

Although in the illustrated embodiments, ambient air is drawn into the first nozzle 1 and the second nozzle 2, in alternative embodiments, a pump may supply pressurized air to the first nozzle 1 and the second nozzle 2.

In the illustrated embodiment, to achieve the connection of two nozzle bases 11 through the water pipe 3, the nozzle base 11 of the first nozzle 1 extends out of the water pipe 3 on the side away from the water inlet end 111. The water pipe 3 is inserted into the nozzle base 11 of the second nozzle 2 and fixedly connected to the second nozzle 2 through a fixing nut 13. A stopper 14 may fit within fixing nut 13 and may improve the seal between water pipe 3 and the water inlet end 111 of the nozzle base 11. Stopper 14 may be formed with interlocking features, such as ridges and valleys, that mate with interlocking features formed in the water inlet end 11 of the nozzle base 11 of the second nozzle 2. The stopper 14 may prevent the fixing nut 13 from deforming a sealing gasket 17.

The present disclosure further provides a SPA pool, which comprises a pool body and a nozzle assembly arranged on the pool body. The nozzle assembly may be the nozzle assembly as described above.

The pool body may be an inflatable spa or pool, or a frame pool. In the case of an inflatable spa or pool, having multiple nozzles connected to a common water inlet and/or a common air inlet may reduce the amount of conduits needed internal to the air cavity of the inflatable pool resulting in a reduction in the number of parts and weight of the inflatable pool in the deflated state.

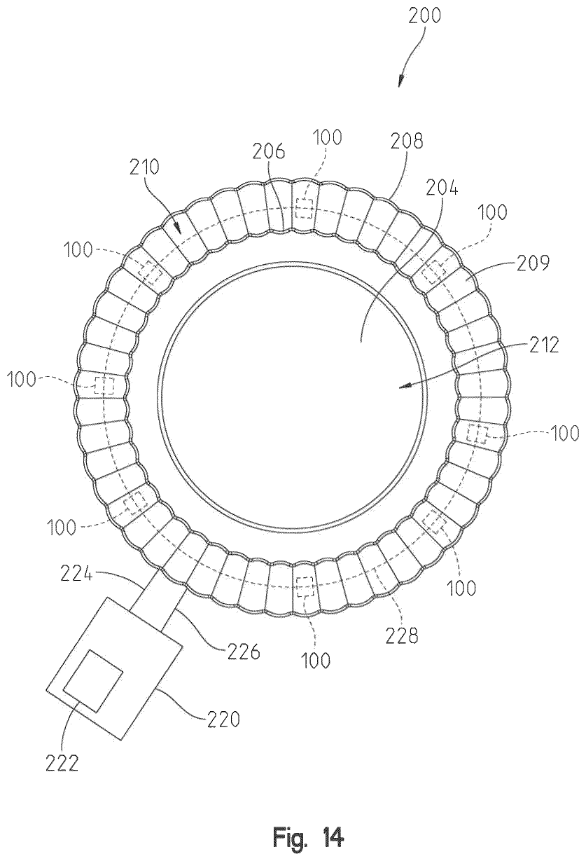

FIG. 14 depicts an exemplary inflatable spa 200. Inflatable spa 200 includes a bottom wall 204, an internal side wall 206, and an external side wall 208. Internal side wall 206 and external side wall 208 cooperate to define an air cavity 210. In embodiments, internal side wall 206 and external side wall 208 cooperate with bottom wall 204 and a top wall 209 to define air cavity 210. Internal side wall 206 and bottom wall 204 cooperate to define a water cavity 212.

Inflatable spa 200 may also include a controller 200 and pump 222. Although not pictured, additional components, such as a water filter, are contemplated.

A feed line 224 may supply water from the water cavity 212 to an inlet of pump 222, and a return line 226 may transport pressurized water from an outlet of pump 222 to the inflatable pool. In embodiments, return line 226 may transport a portion of the pressurized water directly to the water cavity 212 and a portion of the pressurized water to a main supply line 228 disposed in the air cavity 210. Main supply line 228 may span the circumference of the air cavity 210 or less than the circumference of the air cavity 210. Main supply line 228 may be a single line or may be formed of multiple supply lines that make up the main supply line 228.

As shown in FIG. 14, a plurality of nozzle assemblies 100 are disposed in the air cavity 210. The nozzle assemblies 100 are connected to the main supply line 228 such that the inlet waterway 15 of each nozzle assembly 100 connects to the main supply line 228 to receive pressurized water from the pump 222.

As suggested above, if all the first nozzles 1 and second nozzles 2 of the plurality of nozzle assemblies 100 are in an off position, the return line 226 will transport the pressurized water directly into the water cavity 212. This way, even if the user does not wish to use the nozzle features, the water cavity 212 may still receive filtered water from the controller 220.

### Embodiment 2

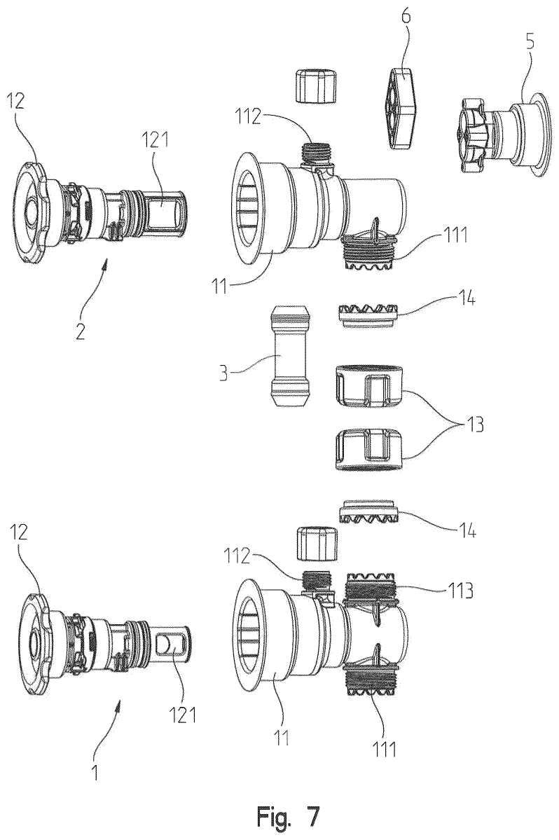

FIGS. 7 to 11 depict another nozzle assembly according to the present disclosure. Here, water pipe 3 is a hose connected between the nozzle bases 11 of the first nozzle 1 and the second nozzle 2. Thus, the first nozzle 1 and the second nozzle 2 are connected via water pipe 3, which may be a hose.

To install the water pipe 3, the nozzle base 11 of the first nozzle 1 has a water outlet end 113 on the side away from the water inlet end 111. The water pipe 3 is connected between the water outlet end 113 of the first nozzle 1 and the water inlet end 111 of the second nozzle 2. The water pipe 3 is fixed to the first nozzle 1 and the second nozzle 2 by fixing nuts 13.

### EXAMPLES

### Example 1

A nozzle assembly for a spa pool may comprise a first nozzle, a second nozzle, and a water pipe. The first nozzle may comprise an air inlet end and a water inlet end. The second nozzle may comprise an air inlet end and a water inlet end. The air inlet ends of the first and second nozzles may be connected to an air inlet valve through an air pipe. The water inlet end of the first nozzle may be connected to an inlet waterway. The water inlet end of the second nozzle may be connected to the inlet waterway through the water pipe.

### Example 2

The nozzle assembly according to Example 1, wherein the first nozzle and the second nozzle may each comprise a nozzle base and a nozzle. The water inlet ends and the air inlet ends of the first and second nozzles may be disposed in the nozzle bases of the first and second nozzles, and each nozzle may be inserted into the corresponding nozzle base. The nozzle may rotate between a first position and a second position relative to the nozzle base under external force.

### Example 3

The nozzle assembly according to Example 2, wherein the nozzle may comprise a water hole. When the nozzle is in the first position, the water hole may be connected to the nozzle base. When the nozzle is in the second position, the water hole may be staggered from the nozzle base.

### Example 4

The nozzle assembly according to Example 3, wherein the nozzle base may always be connected to the water inlet end.

### Example 5

The nozzle assembly according to any one of Examples 2-4, wherein the nozzle base of the first nozzle may extend out of the water pipe on a side away from the water inlet end. The water pipe may be inserted into the nozzle base of the second nozzle and may fixedly be connected to the second nozzle through a fixing nut.

### Example 6

The nozzle assembly according to any one of Examples 2-4, wherein the water pipe may be a hose connected between the nozzle bases of the first nozzle and the second nozzle.

### Example 7

The nozzle assembly according to example 6, wherein the nozzle base of the first nozzle may include a water outlet end on a side away from the water inlet end, and the hose may be connected between the water outlet end of the first nozzle and the water inlet end of the second nozzle. The hose may be respectively fixed thereto by fixing nuts.

### Example 8

A spa pool, wherein the spa pool may comprise a pool body and a nozzle assembly arranged on the pool body. The nozzle assembly may be the nozzle assembly for a spa pool according to any one of Examples 1-7.

### Example 9

The spa pool according to Example 8, wherein the pool body may be an inflatable pool or a frame pool.

### Example 10

A nozzle assembly for a spa pool may comprise an air inlet valve, a first nozzle, and a second nozzle. The air inlet valve may comprise an air inlet in fluid communication with ambient air, an internal volume in fluid communication with the air inlet, and a plurality of air outlets in fluid communication with the internal volume. The first nozzle may comprise an air inlet in fluid communication with a first of the plurality of air outlets and a water inlet in fluid communication with an inlet waterway. The second nozzle may comprise an air inlet in fluid communication with a second of the plurality of air outlets and a water inlet in fluid communication with the inlet waterway.

### Example 11

The nozzle according to Example 10, wherein the first nozzle may comprise a nozzle base and a nozzle head, the water inlet of the first nozzle may be formed in the nozzle base, the nozzle base may include a water outlet in fluid communication with the water inlet of the first nozzle, and the nozzle head may be rotatably received within the nozzle base to rotate between a first position and a second position.

### Example 12

The nozzle according to Example 11, wherein the nozzle head may include an internal fluid passageway having a water inlet hole and a water outlet and, when the nozzle head is in the first position, the water inlet hole may be opened relative to the water inlet of the first nozzle to place the internal fluid passageway of the nozzle head in fluid communication with the inlet waterway.

### Example 13

The nozzle according to Example 11, wherein the nozzle head may include an internal fluid passageway having a water inlet hole and a water outlet and, when the nozzle head is in the second position, the water inlet hole may be closed relative to the water inlet to fluidly isolate the internal fluid passageway of the nozzle head from the inlet waterway.

### Example 14

The nozzle according to Example 13, wherein the second nozzle may receive water from the inlet waterway independent of the nozzle head of the first nozzle such that when the nozzle head of the first nozzle is in the second position the second nozzle may maintain fluid communication with the inlet waterway.

### Example 15

The nozzle according to Example 11, may further comprise a water pipe integrally formed with the nozzle base of the first nozzle and in fluid communication with the water outlet of the first nozzle and the water inlet of the second nozzle to place the second nozzle in fluid communication with the inlet waterway.

### Example 16

The nozzle according to Example 11, may further comprise a water pipe removably couplable the water outlet of the first nozzle and the water inlet of the second nozzle to place the second nozzle in fluid communication with the inlet waterway.

### Example 17

The nozzle according to Example 10, wherein the second nozzle may comprise a nozzle base and a nozzle head, the water inlet of the second nozzle may be formed in the nozzle base, the nozzle head may be rotatably received within the nozzle base to rotate between a first position and a second position.

### Example 18

The nozzle according to Example 17, wherein the nozzle head may include an internal fluid passageway having a water inlet hole and a water outlet and, when the nozzle head is in the first position, the water inlet hole may be opened relative to the water inlet to place the internal fluid passageway of the nozzle head in fluid communication with the inlet waterway.

### Example 19

The nozzle according to Example 17, wherein the nozzle head may include an internal fluid passageway having a water inlet hole and a water outlet and, when the nozzle head is in the second position, the water inlet hole may be closed relative to the water inlet to fluidly isolate the internal fluid passageway of the nozzle head from the inlet waterway.

### Example 20

The nozzle according to Example 17, wherein the first nozzle may receive water from the inlet waterway independent of the nozzle head of the second nozzle such that when the nozzle head of the second nozzle is in the second position the first nozzle may maintain fluid communication with the inlet waterway.

### Example 21

The nozzle according to Example 20, wherein when the nozzle head of the first nozzle is in the first position, water may be communicated from the inlet waterway to the second nozzle through an interior of the nozzle head of the first nozzle and when the first nozzle is in the second position, water may be communicated from the inlet waterway to the second nozzle externally to the nozzle head of the first nozzle.

### Example 22

The nozzle according to Example 10, wherein the first nozzle may further comprise a nozzle head, and wherein the second nozzle may further comprise a nozzle head, the nozzle head of the first nozzle and the nozzle head of the second nozzle may be in independent fluid communication with the inlet waterway.

### Example 23

The nozzle according to Example 10, wherein the first air outlet and the second air outlet may be vertically offset relative to each other.

### Example 24

The nozzle according to Example 10, wherein the first air outlet and the second air outlet may be horizontally offset relative to each other.

### Example 25

A fluid assembly for a SPA pool may comprise a plurality of air pipes, a first nozzle, a second nozzle, an inlet waterway, and a main supply line. The plurality of air pipes may be in fluid communication with ambient air. The first nozzle may comprise an air inlet in fluid communication with ambient air through a first air pipe of the plurality of air pipes, a water inlet, and a water outlet in fluid communication with the water inlet. The second nozzle may comprise an air inlet in fluid communication with ambient air through a second air pipe of the plurality of air pipes, and a water inlet in fluid communication with the water outlet of the first nozzle. The inlet waterway may be in fluid communication with the water inlet of the first nozzle and the water inlet of the second nozzle through the water inlet of the first nozzle and the water outlet of the first nozzle. The main supply line may be in fluid communication with the inlet waterway such that the first nozzle and the second nozzle receive water from the main supply line through the inlet waterway.

### Example 26

The fluid assembly according to Example 25, may further comprise a pump in fluid communication with the spa pool, the main supply line receiving water from the pump.

### Example 27

The fluid assembly according to Example 25, wherein the first nozzle may further comprise a nozzle base and a nozzle head rotatably received within the nozzle base to rotate between a first position and a second position, the water inlet and the water outlet may be formed in the nozzle base, and the nozzle head may comprise an internal fluid passageway having a water inlet hole and a water outlet, the water inlet hole may be in selective fluid communication with the water inlet.

### Example 28

The fluid assembly according to Example 27, wherein, when the nozzle head is in the first position, the water inlet hole may be opened relative to the water inlet of the first nozzle to place the internal fluid passageway of the nozzle head in fluid communication with the inlet waterway.

### Example 29

The fluid assembly according to Example 27, wherein, when the nozzle head is in the second position, the water inlet hole may be closed relative to the water inlet to fluidly isolate the internal fluid passageway of the nozzle head from the inlet waterway.

### Example 30

The fluid assembly according to Example 29, wherein the second nozzle may receive water from the inlet waterway independent of the nozzle head of the first nozzle such that when the nozzle head of the first nozzle is in the second position the second nozzle may maintain fluid communication with the inlet waterway.

### Example 31

The fluid assembly according to Example 25, wherein the second nozzle may further comprise a nozzle base and a nozzle head rotatably received within the nozzle base to rotate between a first position and a second position, the water inlet may be formed in the nozzle base, and the nozzle head may comprise an internal fluid passageway having a water inlet hole and a water outlet, the water inlet hole may be in selective fluid communication with the water inlet.

### Example 32

The fluid assembly according to Example 31, wherein, when the nozzle head is in the first position, the water inlet hole may be opened relative to the water inlet of the second nozzle to place the internal fluid passageway of the nozzle head in fluid communication with the inlet waterway.

### Example 33

The fluid assembly according to Example 31, wherein, when the nozzle head is in the second position, the water inlet hole may be closed relative to the water inlet of the second nozzle to fluidly isolate the internal fluid passageway of the nozzle head from the inlet waterway.

### Example 34

The fluid assembly according to Example 33, wherein the first nozzle may receive water from the inlet waterway independent of the nozzle head of the second nozzle such that when the nozzle head of the second nozzle is in the second position the first nozzle may maintain fluid communication with the inlet waterway.

### Example 35

The fluid assembly according to Example 25, wherein the first air pipe and the second air pipe may be vertically offset relative to each other.

### Example 36

The fluid assembly according to Example 25, wherein the first air pipe and the second air pipe may be horizontally offset relative to each other.

### Example 37

An inflatable spa may comprise an inflatable wall and the fluid assembly according to any one of Examples 25-36. The inflatable wall may comprise an internal wall defining a water cavity and an external wall. The main supply line may be positioned within the inflatable wall.

### Example 38

The inflatable spa according to Example 37, may further comprise a plurality of air inlets formed in the external wall. The plurality of air inlets may be in fluid communication with ambient air.

### Example 39

The inflatable spa according to Example 38, wherein each air inlet of the plurality of air inlets may be in fluid communication with at least one of the plurality of air pipes.

It will be apparent to those skilled in the art that various modifications and variation can be made in the present disclosure without departing from the spirit or scope of the disclosure. Thus, it is intended that the present disclosure cover the modifications and variations of this disclosure provided they come within the scope of the appended claims and their equivalents.

1. A nozzle assembly for a SPA pool comprising:
a first nozzle having an air inlet end, a water inlet end, an internal passageway in selective fluid communication with the water inlet end, and a bypass in selective fluid communication with the water inlet end, the first nozzle configurable in a first configuration and a second configuration,
a second nozzle having an air inlet end and a water inlet end, and
a water pipe connecting the first nozzle and the second nozzle,
wherein the air inlet ends of the first nozzle and second nozzle are connected to an air inlet valve through an air pipe,
wherein the water inlet end of the first nozzle is connected to an inlet waterway,
wherein the water inlet end of the second nozzle is connected to the inlet waterway through the water pipe,
wherein, when the first nozzle is in the first configuration, the second nozzle is in fluid communication with the inlet waterway through the internal passageway of the first nozzle, and
wherein, when the first nozzle is in the second configuration, the second nozzle is in fluid communication with the inlet waterway through the bypass of the first nozzle.

2. The nozzle assembly according to claim 1, wherein the first nozzle and the second nozzle each comprise a nozzle base and a nozzle, the water inlet ends and the air inlet ends of the first and second nozzles are disposed in the nozzle bases of the first and second nozzles, and each nozzle is inserted into the corresponding nozzle base and rotates between a first position and a second position relative to the nozzle base under external force.

3. The nozzle assembly according to claim 2, wherein the nozzle comprises a water hole, and when the nozzle is in the first position, the water hole is connected to the nozzle base, and when the nozzle is in the second position, the water hole is staggered from the nozzle base.

4. The nozzle assembly according to claim 3, wherein the nozzle base is always connected to the water inlet end.

5. The nozzle assembly according to claim 2, wherein the nozzle base of the first nozzle extends out of the water pipe on a side away from the water inlet end, the water pipe is inserted into the nozzle base of the second nozzle and fixedly connected to the second nozzle through a fixing nut.

6. The nozzle assembly according to claim 2, wherein the water pipe is a hose connected between the nozzle bases of the first nozzle and the second nozzle.

7. The nozzle assembly according to claim 6, wherein the nozzle base of the first nozzle has a water outlet end on a side away from the water inlet end, the hose is connected between the water outlet end of the first nozzle and the water inlet end of the second nozzle, and the hose is fixed respectively thereto by fixing nuts.

8. A SPA pool, wherein the SPA pool comprises a pool body and a nozzle assembly arranged on the pool body, the nozzle assembly being the nozzle assembly for SPA pool according to claim 1.

9. The SPA pool according to claim 8, wherein the pool body is an inflatable pool or a frame pool.

10. A nozzle assembly for a SPA pool comprising:
an air inlet valve comprising:
an air inlet in fluid communication with ambient air,
an internal volume in fluid communication with the air inlet, and
a plurality of air outlets in fluid communication with the internal volume;
a first nozzle comprising:
an air inlet in fluid communication with a first of the plurality of air outlets,
a water inlet in fluid communication with an inlet waterway,
a nozzle base including a water outlet in fluid communication with the water inlet, the water inlet formed in the nozzle base, and
a nozzle head rotatably received within the nozzle base to rotate from a first position to a second position, the nozzle head including an internal fluid passageway having a water inlet hole and a water outlet; and
a second nozzle comprising an air inlet in fluid communication with a second of the plurality of air outlets and a water inlet in fluid communication with the inlet waterway,
wherein, when the nozzle head of the first nozzle is in the second position, the water inlet hole is closed relative to the water inlet to fluidly isolate the internal fluid passageway of the nozzle head from the inlet waterway, and
wherein the second nozzle receives water from the inlet waterway independent of the nozzle head of the first nozzle such that, when the nozzle head of the first nozzle is in the second position, the second nozzle maintains fluid communication with the inlet waterway.

11. (canceled)

12. The nozzle assembly of claim 10, wherein when the nozzle head is in the first position, the water inlet hole is opened relative to the water inlet of the first nozzle to place the internal fluid passageway of the nozzle head in fluid communication with the inlet waterway.

13. (canceled)

14. (canceled)

15. The nozzle assembly of claim 10, further comprising a water pipe integrally formed with the nozzle base of the first nozzle and in fluid communication with the water outlet of the first nozzle and the water inlet of the second nozzle to place the second nozzle in fluid communication with the inlet waterway.

16. The nozzle assembly of claim 10, further comprising a water pipe removably couplable the water outlet of the first nozzle and the water inlet of the second nozzle to place the second nozzle in fluid communication with the inlet waterway.

17. The nozzle assembly of claim 10, wherein the second nozzle comprises a nozzle base and a nozzle head, the water inlet of the second nozzle is formed in the nozzle base, the nozzle head rotatably received within the nozzle base to rotate between a first position and a second position.

18. The nozzle assembly of claim 17, wherein the nozzle head of the second nozzle includes an internal fluid passageway having a water inlet hole and a water outlet and, when the nozzle head of the second nozzle is in the first position, the water inlet hole is opened relative to the water inlet to place the internal fluid passageway of the nozzle head of the second nozzle in fluid communication with the inlet waterway.

19. The nozzle assembly of claim 17, wherein the nozzle head of the second nozzle includes an internal fluid passageway having a water inlet hole and a water outlet and, when the nozzle head of the second nozzle is in the second position, the water inlet hole is closed relative to the water inlet to fluidly isolate the internal fluid passageway of the nozzle head from the inlet waterway.

20. The nozzle assembly of claim 17, wherein the first nozzle receives water from the inlet waterway independent of the nozzle head of the second nozzle such that when the nozzle head of the second nozzle is in the second position the first nozzle maintains fluid communication with the inlet waterway.

21. The nozzle assembly of claim 20, wherein when the nozzle head of the first nozzle is in the first position, water is communicated from the inlet waterway to the second nozzle through an interior of the nozzle head of the first nozzle and when the first nozzle is in the second position, water is communicated from the inlet waterway to the second nozzle externally to the nozzle head of the first nozzle.

22. The nozzle assembly of claim 10, wherein the second nozzle further comprises a nozzle head, the nozzle head of the first nozzle and the nozzle head of the second nozzle are in independent fluid communication with the inlet waterway.

23. The nozzle assembly of claim 10, wherein the first air outlet and the second air outlet are vertically offset relative to each other.

24. The nozzle assembly of claim 10, wherein the first air outlet and the second air outlet are horizontally offset relative to each other.

25. A fluid assembly for a SPA pool comprising:
a plurality of air pipes in fluid communication with ambient air;
a first nozzle configurable in a first configuration and a second configuration, the first nozzle comprising:
an air inlet in fluid communication with ambient air through a first air pipe of the plurality of air pipes,
a water inlet,
an internal passageway in selective fluid communication with the water inlet.
a bypass in selective fluid communication with the water inlet, and
a water outlet in fluid communication with the water inlet;
a second nozzle comprising:
an air inlet in fluid communication with ambient air through a second air pipe of the plurality of air pipes, and
a water inlet in fluid communication with the water outlet of the first nozzle;
an inlet waterway in fluid communication with the water inlet of the first nozzle and the water inlet of the second nozzle through the internal passageway of the first nozzle when the first nozzle is in the first configuration and through the bypass of the first nozzle when the first nozzle is in the second configuration; and
a main supply line in fluid communication with the inlet waterway such that the first nozzle and the second nozzle receive water from the main supply line through the inlet waterway.

26. The fluid assembly of claim 25, further comprising a pump in fluid communication with the spa pool, the main supply line receiving water from the pump.

27. The fluid assembly of claim 25, wherein the first nozzle further comprises a nozzle base and a nozzle head rotatably received within the nozzle base to rotate between a first position and a second position, the water inlet and the water outlet are formed in the nozzle base, and the nozzle head comprises the internal fluid passageway having a water inlet hole and a water outlet, the water inlet hole in selective fluid communication with the water inlet.

28. The fluid assembly of claim 27, wherein, when the nozzle head is in the first position, the water inlet hole is opened relative to the water inlet of the first nozzle to place the internal fluid passageway of the nozzle head in fluid communication with the inlet waterway.

29. The fluid assembly of claim 27, wherein, when the nozzle head is in the second position, the water inlet hole is closed relative to the water inlet to fluidly isolate the internal fluid passageway of the nozzle head from the inlet waterway.

30. The fluid assembly of claim 29, wherein the second nozzle receives water from the inlet waterway independent of the nozzle head of the first nozzle such that when the nozzle head of the first nozzle is in the second position the second nozzle maintains fluid communication with the inlet waterway.

31. The fluid assembly of claim 25, wherein the second nozzle further comprises a nozzle base and a nozzle head rotatably received within the nozzle base to rotate between a first position and a second position, the water inlet formed in the nozzle base, and the nozzle head comprises an internal fluid passageway having a water inlet hole and a water outlet, the water inlet hole in selective fluid communication with the water inlet.

32. The fluid assembly of claim 31, wherein, when the nozzle head is in the first position, the water inlet hole is opened relative to the water inlet of the second nozzle to place the internal fluid passageway of the nozzle head in fluid communication with the inlet waterway.

33. The fluid assembly of claim 31, wherein, when the nozzle head is in the second position, the water inlet hole is closed relative to the water inlet of the second nozzle to fluidly isolate the internal fluid passageway of the nozzle head from the inlet waterway.

34. The fluid assembly of claim 33, wherein the first nozzle receives water from the inlet waterway independent of the nozzle head of the second nozzle such that when the nozzle head of the second nozzle is in the second position the first nozzle maintains fluid communication with the inlet waterway.

35. The fluid assembly of claim 25, wherein the first air pipe and the second air pipe are vertically offset relative to each other.

36. The fluid assembly of claim 25, wherein the first air pipe and the second air pipe are horizontally offset relative to each other.

37. An inflatable spa, comprising:
an inflatable wall having an internal wall defining a water cavity and an external wall; and
the fluid assembly of of claim 25, wherein the main supply line is positioned within the inflatable wall.

38. The inflatable spa of claim 37, further comprising a plurality of air inlets formed in the external wall, the plurality of air inlets in fluid communication with ambient air.

39. The inflatable spa of claim 38, wherein each air inlet of the plurality of air inlets is in fluid communication with at least one of the plurality of air pipes.

40. An inflatable spa, comprising:
a bottom wall;
an internal side wall;
an external side wall, the internal side wall and external side wall cooperate to define an air cavity and internal side wall and bottom wall cooperate to define a water cavity;
a main supply line disposed in the air cavity;
a pump;
a feed line to supply water from the water cavity to an inlet of the pump;
a return line to transport pressurized water from an outlet of the pump to the main supply line; and
a plurality of nozzle assemblies, each of the plurality of nozzle assemblies comprising:
an inlet waterway connected to the main supply line independent of the other plurality of nozzle assemblies;
a first nozzle having an air inlet end and a water inlet end, the water inlet end connected to the inlet waterway,
a second nozzle having an air inlet end and a water inlet end, and
a water pipe,
wherein the air inlet ends of the first nozzle and second nozzle are connected to an air inlet valve through an air pipe, and
wherein the water inlet end of the second nozzle is connected to the inlet waterway through the water pipe.
